(19) United States
(12) Patent Application Publication
(10) Pub. No.: US 2012/0017938 A1
(43) Pub. Date: Jan. 26, 2012

(54) PLATEN CLEANING

(75) Inventors: William T. Weaver, Austin, TX (US); Kevin M. Daniels, Lynnfield, MA (US); Dale K. Stone, Lynnfield, MA (US); Russell J. Low, Rowley, MA (US); Benjamin B. Riordon, Newburyport, MA (US); Jeffrey Blahnik, Leander, TX (US)

(73) Assignee: VARIAN SEMICONDUCTOR EQUIPMENT ASSOCIATES, INC., Gloucester, MA (US)

(21) Appl. No.: 13/187,078

(22) Filed: Jul. 20, 2011

Related U.S. Application Data
(60) Provisional application No. 61/366,641, filed on Jul. 22, 2010.

(51) Int. Cl. B08B 1/00

(52) U.S. Cl. 134/6

(57) ABSTRACT

To achieve cost efficiency, solar cells must be processed at a high throughput. Breakages, which may leave debris on the clamping surface of the platen, adversely affect this throughput. A plurality of embodiments are disclosed which may be used to remove debris from the clamping surface without breaking the vacuum condition within the processing station. In some embodiments, a brush is used to sweep the debris from the surface of the platen. In other embodiments, an adhesive material is used to collect the debris. In some embodiments, the automation equipment used to handle masks may also be used to handle the platen cleaning mechanisms. In still other embodiments, stream of gas or ion beams are used to clean debris from the clamping surface of the platen.

This application claims priority of U.S. Provisional Patent Application Ser. No. 61/366,641, filed Jul. 22, 2010, the disclosure of which is incorporated by reference in its entirety.

### FIELD

This disclosure relates to processing tools having a platen, and more particularly, to platen cleaning apparatuses and methods.

### BACKGROUND

One type of processing tool is an ion implanter that treats a workpiece with ions. The ion implanter may be a beam line ion implanter or plasma doping ion implanter. A beam line ion implanter includes an ion source and an extraction electrode assembly to extract a well defined ion beam from the ion source. One or more beamline components known in the art may control and modify the ion beam to obtain an ion beam with desired characteristics, which is directed towards a surface of the workpiece. The ion beam may be distributed across the surface of the workpiece by ion beam movement, workpiece movement, or a combination of the two. The entire path traversed by the ion beam may be pumped to a vacuum condition during ion treatment.

An ion implanter may also include plasma doping ion implanters that generate plasma in a chamber. The workpiece is also positioned in the chamber of the plasma doping ion implanter. Ions from the plasma are attracted towards a surface of a workpiece during certain time intervals.

For either type of ion implanter, the workpiece may include, but not be limited to, a solar cell, a semiconductor substrate, a polymer substrate, and a flat panel. The workpiece is supported by a platen having a clamping surface. The platen may be an electrostatic platen that generates electrostatic forces to clamp the workpiece to the clamping surface as is known in the art. The platen also may physically clamp the workpiece in an alternate embodiment.

Particles or debris may adhere to the clamping surface of the platen and degrade the performance of the same. For instance, the clamping force, clamping release times, and ability of the platen to cool the workpiece may be degraded. One source of particles is from a workpiece breakage event. For example, a solar cell is generally thinner and more fragile than other workpieces. A solar cell may therefore break when being coupled to, or released from, the clamping surface of the platen. Residue and particles from the solar cell itself may adhere to the clamping surface.

One conventional method of cleaning particles from a clamping surface of the platen is to vent a processing station from a vacuum condition to an atmospheric condition to allow personnel access to the platen in the processing station to manually clean the same. One major drawback with this conventional method is the time it takes to accomplish this task. For example, it may take considerable time to pump the processing station back to a vacuum condition after venting of the same and cleaning of the platen. This down time adversely impacts the overall throughput of the ion implanter or the number of workpieces that can be processed in a given time interval.

Accordingly, there is a need for platen cleaning apparatuses and methods that overcome the above described inadequacies and shortcomings.

### SUMMARY

To achieve cost efficiency, solar cells must be processed at a high throughput. Breakages, which may leave debris on the clamping surface of the platen, adversely affect this throughput. A plurality of embodiments are disclosed which may be used to remove debris from the clamping surface without breaking the vacuum condition within the processing station. In some embodiments, a brush is used to sweep the debris from the surface of the platen. In other embodiments, an adhesive material is used to collect the debris. In some embodiments, the automation equipment used to handle masks may also be used to handle the platen cleaning mechanisms. In still other embodiments, stream of gas or ion beams are used to clean debris from the clamping surface of the platen.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of a beam line ion implanter;

FIG. 2A is a block diagram of a processing station of the beam line ion implanter of FIG. 1 having a platen cleaning apparatus according to one embodiment of the disclosure;

FIG. 2B is a perspective view of another platen cleaning apparatus;

FIG. 2C is a top view of the platen cleaning apparatus of FIG. 2B;

FIG. 2D is a side view of the platen cleaning apparatus of FIG. 2B in the operative position;

FIG. 2E is a side view of the platen cleaning apparatus of FIG. 2B in the stowed position;

FIG. 2F is a view of the connection between the arm and support of the platen cleaning apparatus of FIG. 2B;

FIGS. 3A-C are partial perspective and cross sectional views of another platen cleaning apparatus according to another embodiment of the disclosure;

FIG. 4 shows the sequence used to clean a platen using the platen cleaning apparatus of FIGS. 3A-C;

FIGS. 5A-C is a partial perspective and cross sectional view of another embodiment of a cleaning apparatus having a double-sided brush;

FIGS. 6A-C are partial perspective and cross sectional views of another platen cleaning apparatus according to another embodiment of the disclosure having an adhesive roller;

FIG. 7 shows the sequence used to clean a platen using the platen cleaning apparatus of FIGS. 6A-C;

FIG. 8 is a perspective view of another embodiment of a cleaning apparatus having an adhesive sheet;

FIGS. 9A-B is a sequence showing a cross sectional view of a mechanism to controllably remove an adhesive sheet from a platen; and

FIG. 10 is a perspective view of a platen cleaning apparatus having an adhesive sheet.

### DETAILED DESCRIPTION

The present invention will now be described more fully hereinafter with reference to the accompanying drawings, in which embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

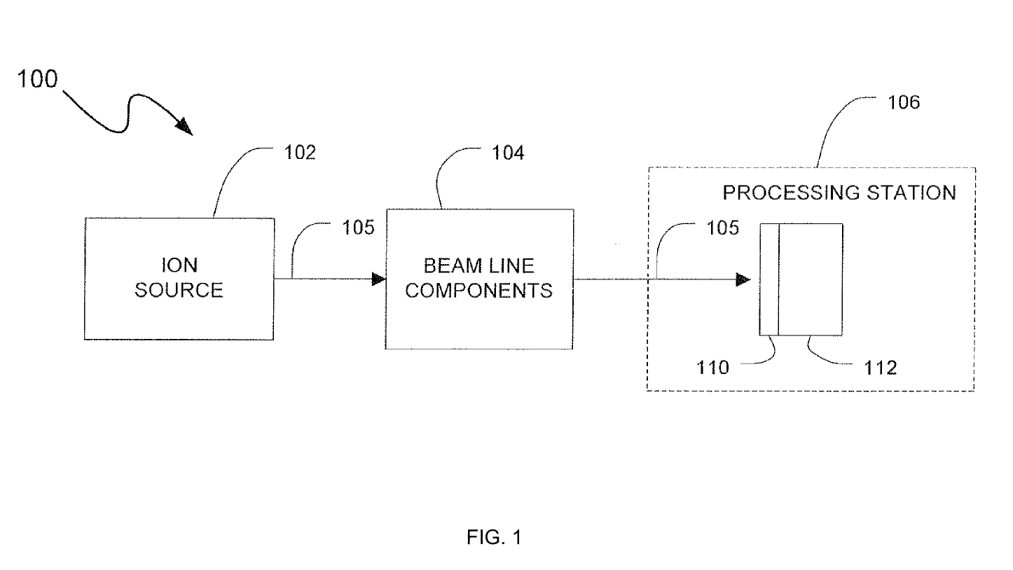

Turning to FIG. 1, a simplified schematic block diagram of a beam line ion implanter 100 is illustrated. The beam line ion implanter 100 includes an ion source 102, beam line components 104, and a processing station 106 that supports one or more workpieces such as a workpiece 110. The ion source 102 generates an ion beam 105 that is directed via the beam line components 104 to the workpiece 110.

The beam line components 104 may include components known to those skilled in art to control and direct the ion beam 105 towards the workpiece 110. Some examples of such beam line components 104 include, but are not limited to, a mass analyzing magnet, a resolving aperture, ion beam acceleration and/or deceleration columns, an energy filter, and a collimator magnet or parallelizing lens. Those skilled in the art will recognize alternative and/or additional beam line components 104 that may be utilized in the ion implanter 100.

The processing station 106 supports one or more workpieces, such as workpiece 110, in the path of ion beam 105 such that ions of the desired species strike the workpiece 110. The workpiece 110 may be, for example, one or more solar cells receiving ion treatment. The processing station 106 may include a platen 112 to support the workpiece 110. The platen 112 may secure the workpiece 110 using electrostatic forces. The end station 106 may also include a scanner (not illustrated) for moving the workpiece 110 in a desired direction.

The processing station 106 may also include additional components known to those skilled in the art. For example, the processing station 106 typically includes automated workpiece handling equipment for introducing workpieces into the ion implanter 100 and for removing workpieces after ion treatment. It will be understood to those skilled in the art that the entire path traversed by the ion beam 105 is evacuated during ion treatment. The ion implanter 100 may also have a controller (not illustrated) to control a variety of subsystems and components of the ion implanter 100.

A plurality of different platen cleaning apparatuses is described herein. These devices may utilize a plurality of different mechanisms, such as mechanical movement to push debris from the platen, or adhesion to draw debris away from the platen.

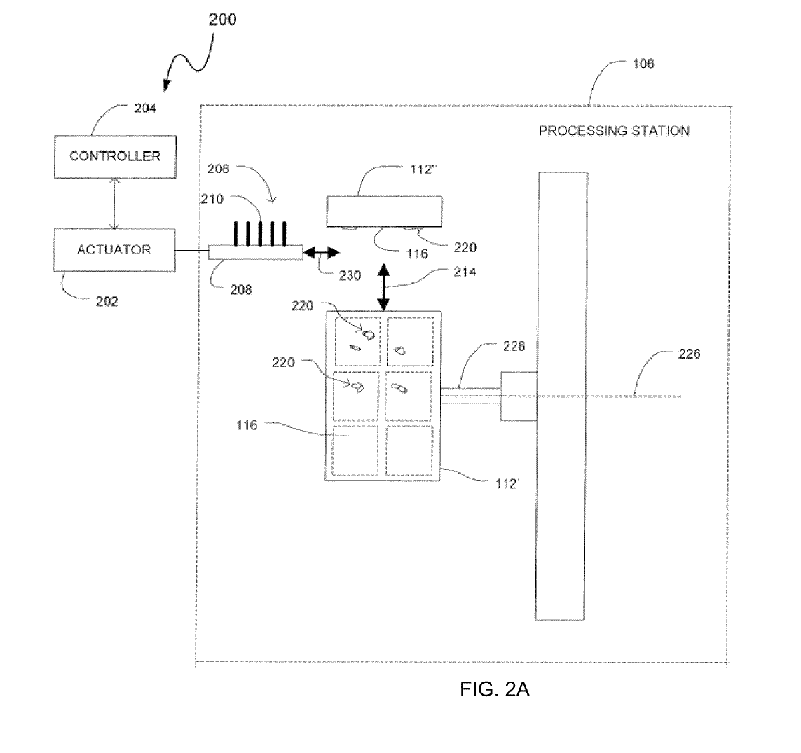

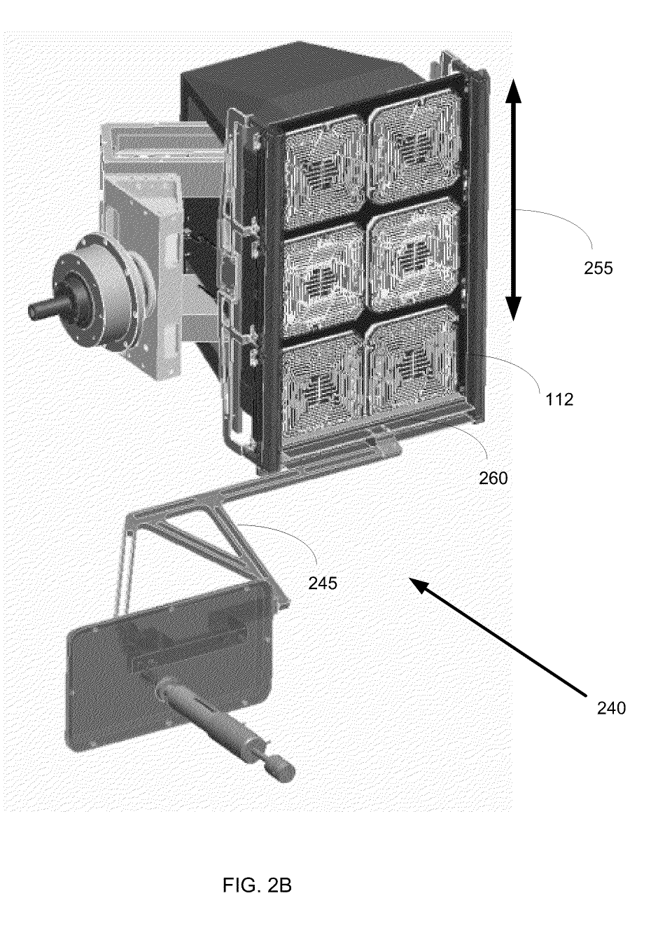

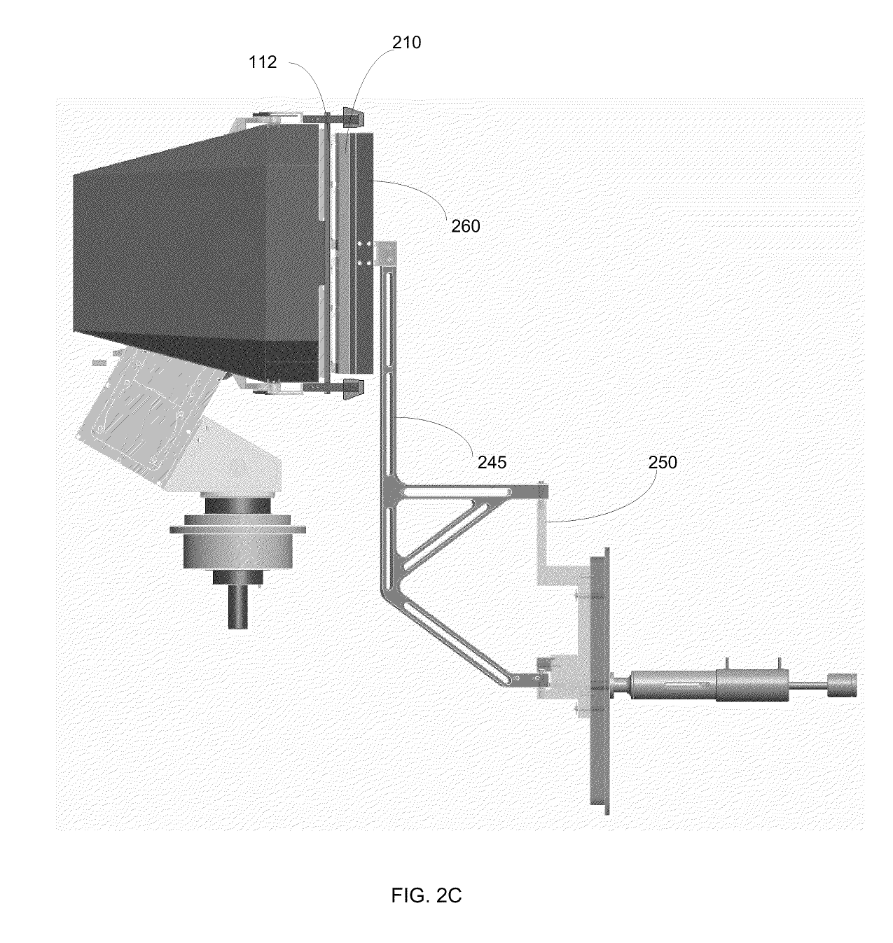

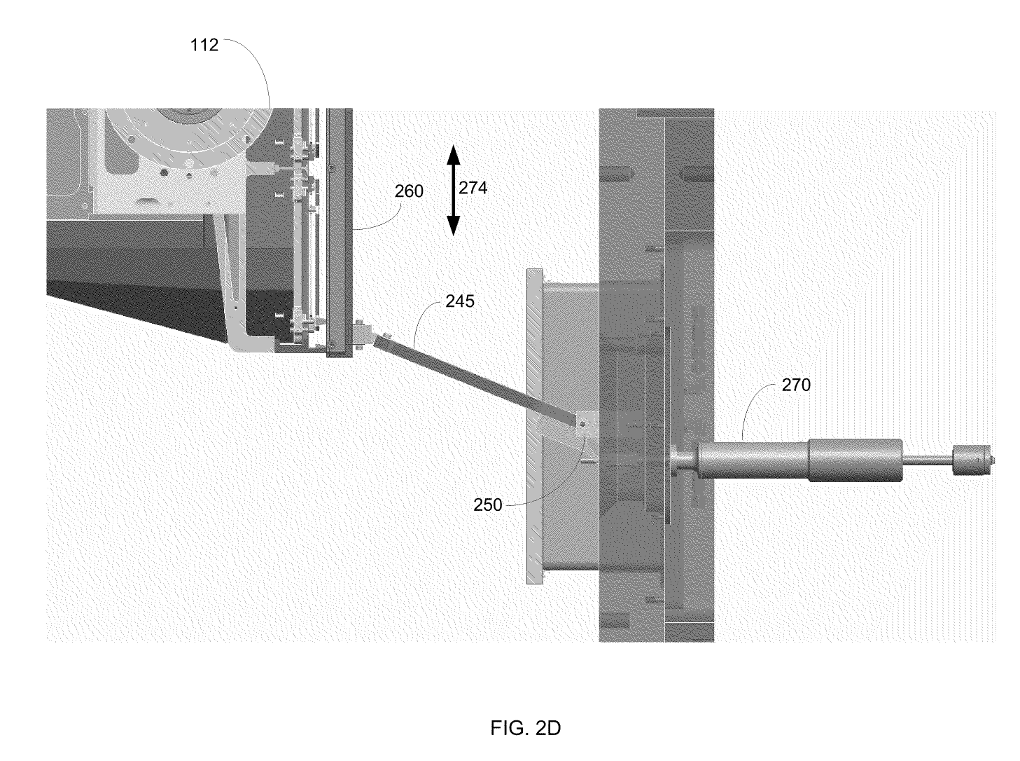

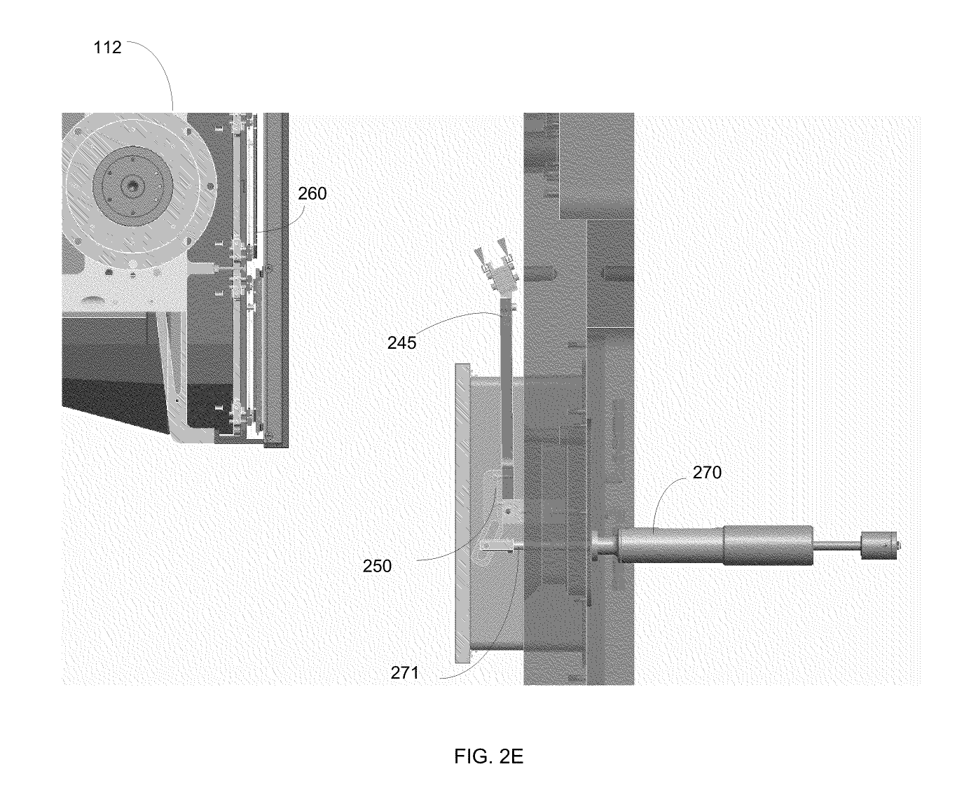

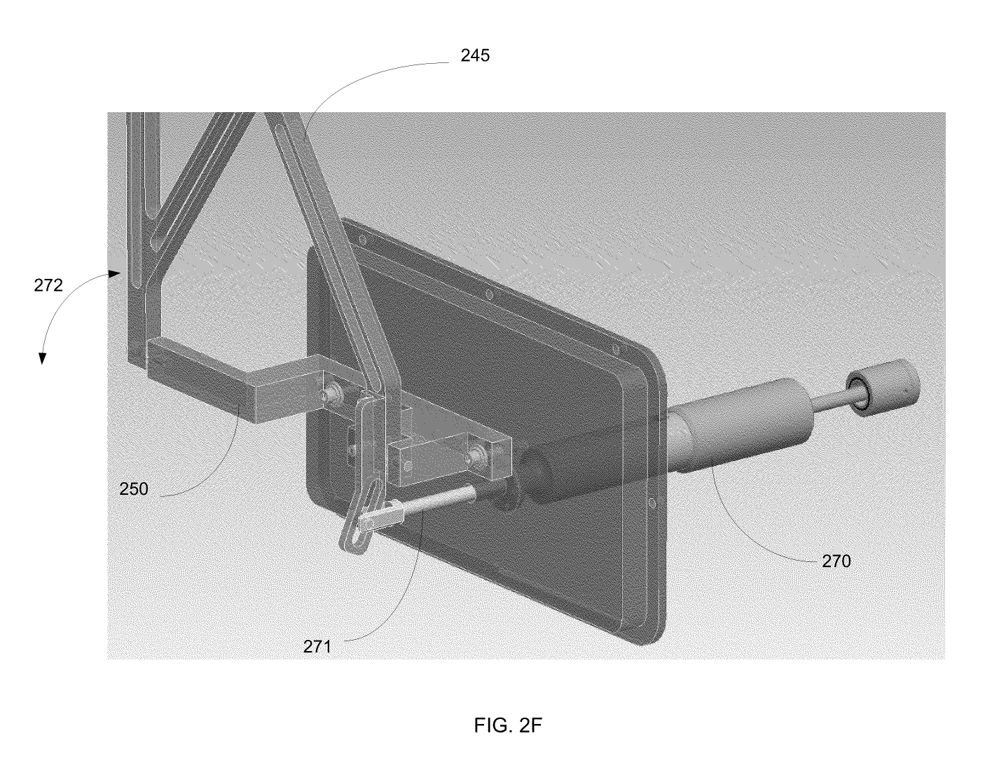

FIG. 2A shows a first embodiment, which utilizes a brush-like mechanism. In FIG. 2A, a diagram of a platen cleaning apparatus 200 looking downstream in a direction of travel of the ion beam 105 is illustrated. The platen cleaning apparatus 200 is configured to clean a clamping surface 116 of the platen 112 without breaking a vacuum condition of the processing station 106. The platen cleaning apparatus 200 may include an actuator 202, a controller 204, and a platen cleaning device, such as a brush 206. The actuator 202 may include a motor and drive mechanism to drive the platen cleaning device 206 from a parked position to cleaning positions. The controller 204 can be or include a general-purpose computer or network of general-purpose computers that may be programmed to perform desired input/output functions. The controller 204 can also include other electronic circuitry or components, such as application specific integrated circuits, other hardwired or programmable electronic devices, discrete element circuits, etc. For clarity of illustration, the controller 204 is illustrated as providing an output signal to the actuator 202 and receiving signals from the same. Those skilled in the art will recognize that the controller 204 may provide output signals to other components of the beam line ion implanter 100 and receive input signals from the same. The platen cleaning device 206 may further include a head 208 and bristles 210. The bristles 210 may be made of materials strong enough to remove particles 220 from the clamping surface 116 of the platen 112 yet gentle enough to not damage the clamping surface 116. The bristles 310 of this and other embodiments may be any type of object or material that performs a cleaning operation. In some embodiments, the bristles may be nylon, polypropylene or Teflon. In other embodiments, the bristles of this or other embodiments may be conductive, so as to remove any built up charge from the platen, while removing debris. These conductive bristles, or fingers, may be grounded to facilitate removal of excess charge from the platen 112.

In operation, the platen 112 may have a rectangular shape and be sized to accommodate six solar cells in a 2×3 matrix. When the platen is in an implanting position 112′ an ion beam may strike six solar cells (illustrated in phantom) clamped to a clamping surface 116 of the platen. Particles 220, shown in exaggerated size, may accumulate on the clamping surface 116 of the platen due to different conditions including solar cell breakage. To clean the clamping surface 116, the platen 112 may be driven in a “Y” direction 214 to a cleaning position 112″. A scan arm 228 is configured to rotate about an axis 226 to position the clamping surface 116 facing downward as shown in the position 112″. The actuator 202 may then drive the brush 206 to and from in the direction indicated by arrow 230 so the bristles 210 contact and clean the clamping surface 116 by removing particles 220. Since the clamping surface 116 is facing downward, the particles 220 would fall downward due to gravity. The platen 112 may then be rotated and driven in the “Y” direction 214 back to the position 112′ for further processing of additional workpieces after receipt of the same.

A view port (not illustrated) may provide a viewing window for an operator to inspect the clamping surface 116. In addition, a camera (not illustrated) may also be used to verify the condition of the clamping surface 116 after a cleaning operation.

The bristle 210 material may be vacuum compatible and not impact metals. A cleaning station (not illustrated) may also be added to clean the brush 206 of particles. An air jet could be used in the cleaning station to blow particles from the bristles 210 and/or another “comb” type device could be mechanically driven through the bristles 210 to clean the same.

Another embodiment that utilizes a brush-like mechanism is shown in FIGS. 2B-2F. In FIG. 2B, the platen 112 is shown in the vertical position, although any position in which gravity aids in the removal of debris can be used. The platen cleaning apparatus 240 includes a rotatable arm 245, pivotably attached to a support 250 (see FIG. 2C) at one end, and having a brush 260 with bristles 210 at the opposite end. The brush 260 extends to contact the platen 112. To clean the platen 112, an actuator moves the platen up and down, as shown by arrow 255. This motion removes debris from the platen 112.

Turning to FIG. 2F, a close-up view of the support 250, rotatable arm 245 and actuator 270 is shown. The actuator 270 has a piston 271, which may be extended and retracted. When the piston 271 is extended, as shown in FIG. 2F, the rotatable arm 245 rotates along arc 272 to its stowed position. When the piston is retracted, it causes the arm 245 to rotate along arc 272 to the cleaning position, as shown in FIGS. 2B and 2D. The actuator 270 can be controlled by a controller 204 (FIG. 2A), or any other mechanism.

FIG. 2D shows the arm 245 rotated so as to contact the platen in the cleaning position. In this position, the piston 271 is retracted. The brush 260 is in contact with the platen 112. The platen 112 then is translated in the vertical direction, as shown in arrow 274, to remove debris. FIG. 2E shows the arm 245 rotated to the stowed position. In this position, the piston 271 is extended. While the platen cleaning apparatus is within the processing station, the brush 2600 is out of the path of the ion beam when in this position.

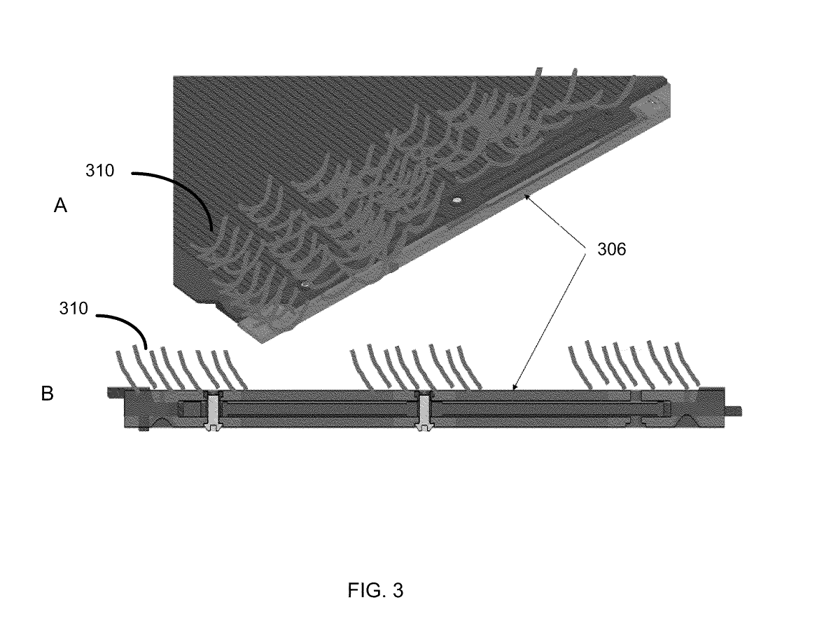

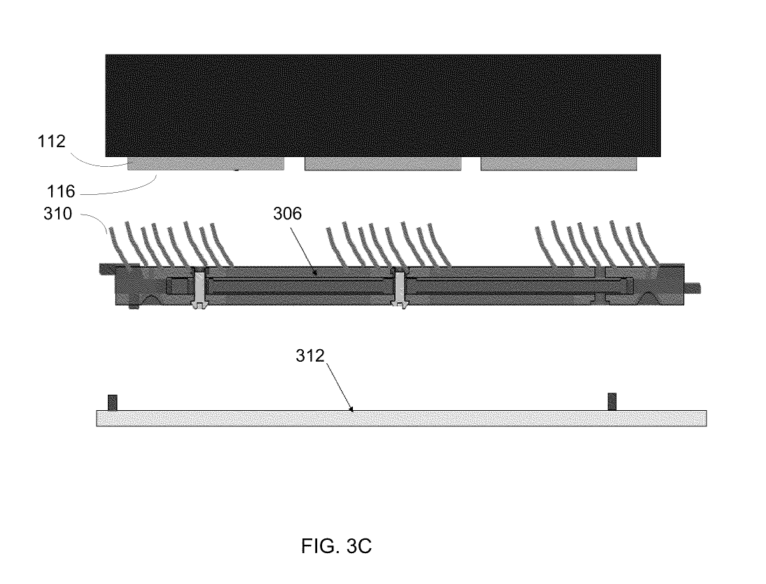

Turning to FIGS. 3A-C, yet another embodiment of the present disclosure is illustrated having a platen cleaning device, such as a mask brush 306. FIG. 3A shows a perspective view of a mask brush 306, while FIG. 3B shows a cross-sectional view. FIG. 3C shows the mask brush 306 positioned between the platen 112 and the robot end effector 312.

In general, a mask may be used in the beam line ion implanter 100 to define selected areas for ion treatment. This mask may be a proximity mask or shadow mask, for example. The beam line ion implanter 100 may also include differing mask handling robots with associated end effectors 312 to retrieve the mask and/or mask-like structure and position the same upstream of the workpiece. A brush including bristles 310 may be affixed to a mask or a mask-like structure to form the mask brush 306.

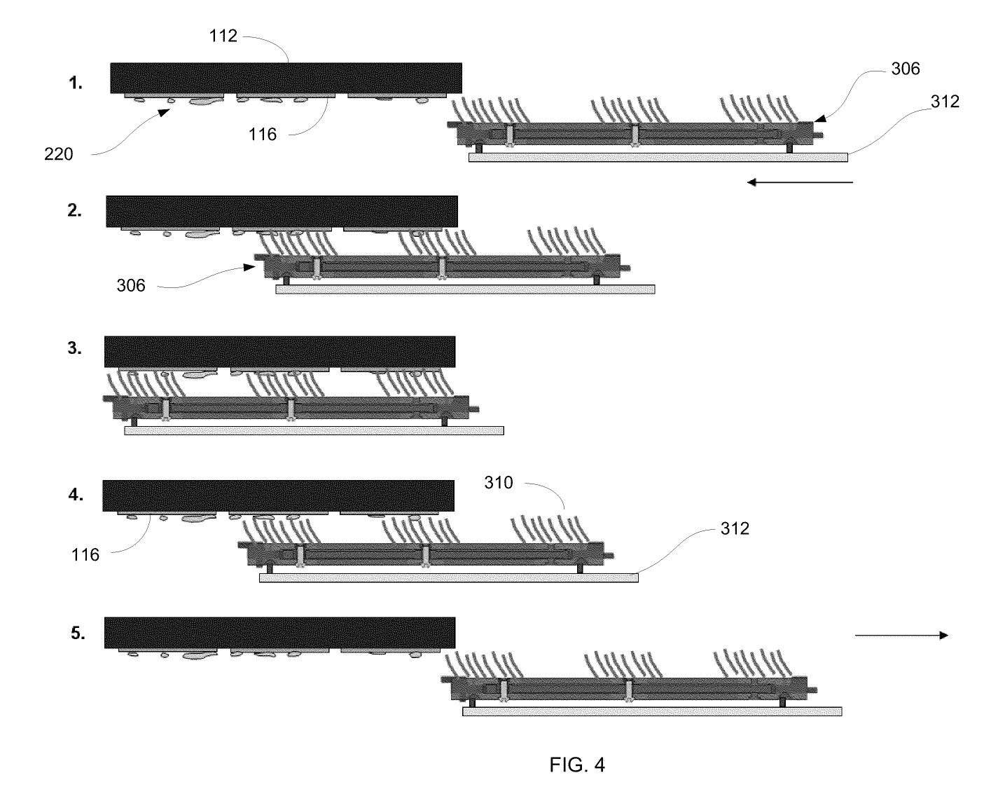

Turning to FIG. 4, a cross sectional view of a mask brush 306 having bristles 310 to clean the clamping surface 116 of the platen 112 is illustrated in different operational positions. To initiate the cleaning operation, the platen 112 would be driven to a similar position 112″ of FIG. 2 with its clamping surface 116 facing downward as illustrated in step (1) of FIG. 4. As described above, the platen 112 may be rotated such that the clamping surface 116 is facing downward, or another direction in which gravity aids in the removal of debris. In this position, the end effector 312 may not be in contact with the platen 112.

An end effector 312 of a robot may engage and secure a mask brush 306 having bristles 310 affixed thereto. The end effector 312, with the mask brush 306 secured thereto may extend toward the platen 112 as shown in step (2). The end effector 312 with the mask brush 306 may extend so as to contact the entirety of clamping surface 116, as shown in step (3). In step (4), the end effector 312 begins retracting away from the platen 112. In step (5) the end effector 312 retracts away from the platen 112 so as not to be in contact with the platen 112. The end effector 112 may move to and from the platen, as shown in steps (2)-(5), one or more times so that the bristles 310 contact the clamping surface 116 to clean the same by removing most, if not all, of the particles 220 stuck to the clamping surface 116. The inverted orientation of the platen 112 ensures that once the particles 220 are dislodged by the bristles 310, they fall away from the platen 112 due to gravity.

After the clamping surface 116 has been cleaned, the end effector 312 of a robot may disengage the mask brush 306. The robot is then free to engage a different mask, such as one used to create patterned implants. Thus, the mask brush 306 enables the use of an existing piece of equipment to perform this cleaning operation.

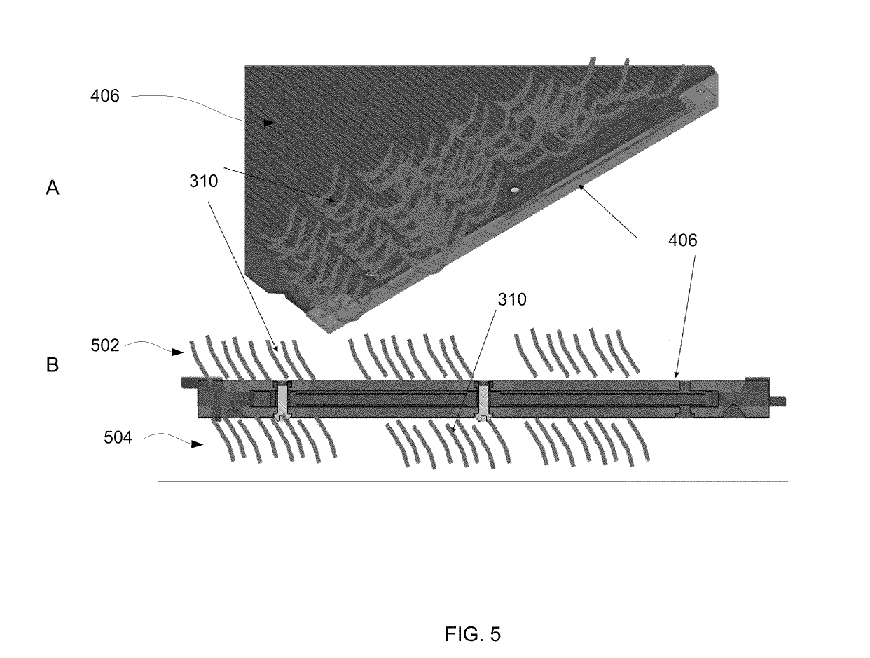

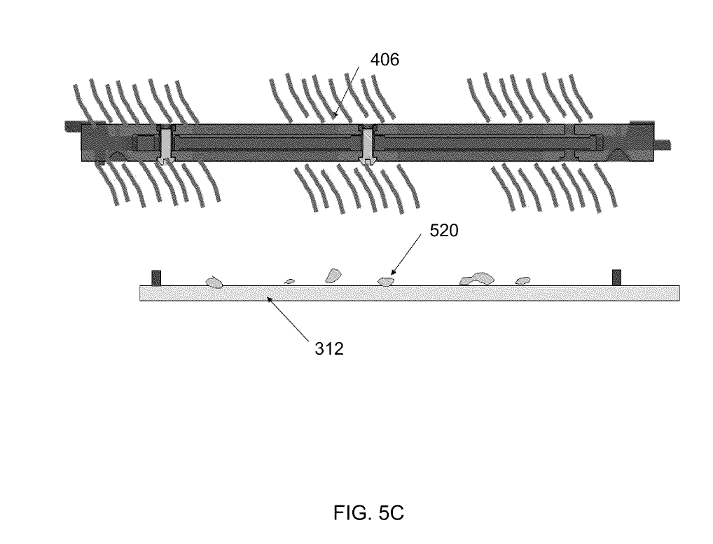

Turning to FIG. 5A-C, yet another embodiment is illustrated having a double-sided mask brush 406. FIG. 5A shows a perspective view of a double-sided mask brush 406, while FIG. 5B shows a cross-sectional view. FIG. 5C shows the double-sided mask brush 406 positioned relative to the robot end effector 312.

In a double-sided mask brush 406, a first set 502 of bristles 310 may be positioned on one side and a second set 504 of bristles may be positioned on an opposing side of the mask brush 406. The embodiment of FIGS. 5A-C is similar to embodiment of FIGS. 3A-C and 4 with the main different being the additional set 504 of bristles 310 facing the end effector 312. This set 504 of bristles 310 allows the end effector 312 to be cleaned any time there is relative motion between the set 504 of bristles 310 and the end effector 312. This relative motion may be used to clean the end effector of particles such as particles 520 resulting from a broken wafer event.

In operation, the double-sided mask brush 406 may be in a storage location, such as a shelf, and retrieved by an end effector 312 of an associated robot. The end effector 312 may be positioned underneath the double-sided mask brush and then the double-sided mask brush 406 may be lowered onto the end effector 312. The end effector 312 with the double-sided mask brush 406 affixed thereto may then clean the clamping surface 116 of the platen 112 similar to the steps (1)-(5) detailed in FIG. 4. The additional set 504 of bristles 310 can clean the end effector 312 during the extension or retraction operation or essentially anytime there is relative motion between the end effector 312 and the second set 504 of bristles 310. Again, the bristles 310 of this and other embodiments may be any type of object or material that performs a cleaning operation.

In each of the previous embodiments, a platen cleaning device having bristles on at least one surface is disclosed. This platen cleaning device may attached to a robot end effector, either permanently or may be removably held by the end effector. In another embodiment, the platen cleaning device is attached to an actuator which moves the platen cleaning device. In all of these embodiments, the platen cleaning device is attached to a movable arm, which can be extended or retracted from the platen.

The platen cleaning device is used to sweep debris from the platen, preferably when an ion implantation is not occurring. When implantation is occurring, the platen cleaning device is located so as not to be in the path of the ion beam. When ion implantation is not occurring, the platen may be cleaned. During this time, the platen may be rotated or otherwise moved such that the clamping surface is facing downward, or another direction in which gravity aids in the removal of debris . The movable arm with the platen cleaning device having bristles is then extended and retracted so as to sweep debris from the platen. Since the surface of the platen is facing downward, the debris falls, due to gravity.

In the embodiment of FIG. 2, the movable arm may be dedicated to this cleaning operation, in that it is not used for any other purposes. In this embodiment, the actuator and controller are used to control the platen cleaning device.

In the embodiments of FIGS. 3A-C and 5A-C, the movable arm may be an end effector, capable of also be used to engage, position and disengage masks during ion implantation. In these embodiments, the platen cleaning device having the bristles may be shaped like a traditional mask or may be a mask-like structure. A mask-like structure, as defined herein, is a device having a size and shape such that the end effector may engage it as it would a traditional mask. Thus, a mask-like structure includes both masks and similarly shaped carriers or other structures.

Each of these platen cleaning devices is configured to clean a clamping surface 116 of the platen 112 without breaking a vacuum condition of the processing station 106.

While the disclosure describes bristles in conjunction with the embodiments of FIGS. 2-5, it is understood that any cleaning mechanism suitable for moving across the surface of the platen and mechanically removing debris may be used.

In addition to sweeping, other methods may be used to remove debris from a platen.

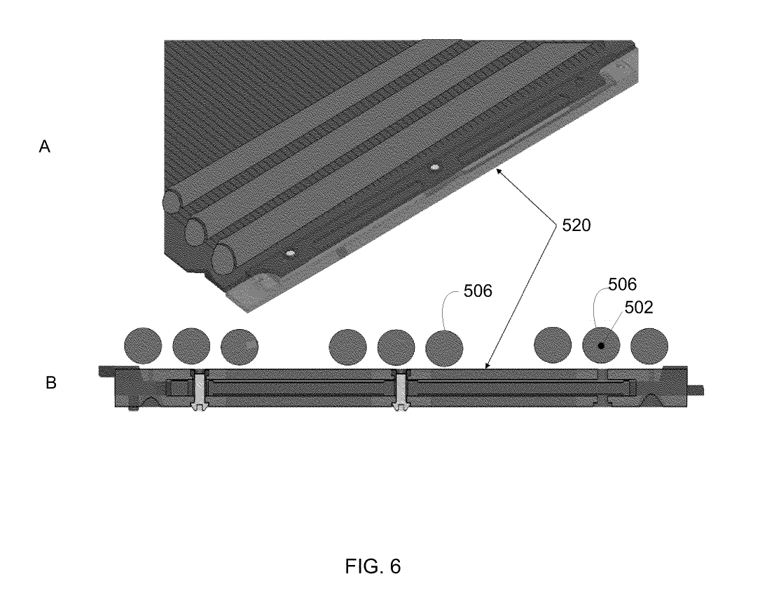

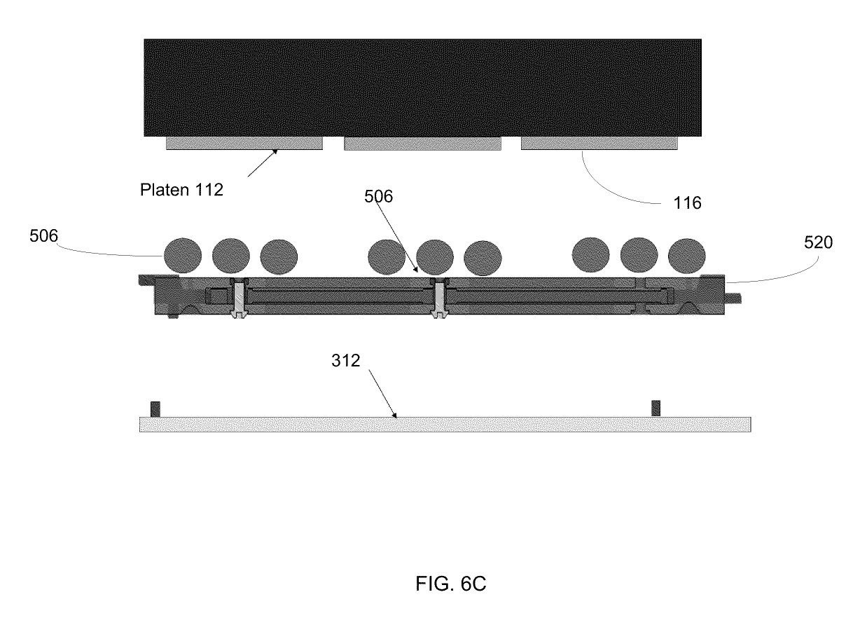

Turning to FIGS. 6A-C, yet another embodiment of the present disclosure is illustrated having an adhesive roller 506 fixed to an object 520, such as a mask-like structure. A mask-like structure, as defined herein, is a device having a size and shape such that the end effector may engage it as it would a traditional mask. Thus, a mask-like structure includes both masks and similarly shaped carriers or structures. FIG. 6A shows a perspective view of an adhesive roller 506, while FIG. 6B shows a cross-sectional view. FIG. 6C shows the adhesive roller 506 positioned relative to the platen 112 and the robot end effector 312.

The adhesive roller 506 may include an adhesive material, such as tape, that can clean the clamping surface 116 of the platen 112 while leaving little harmful residue. A plurality of adhesive rollers may be fixed to the object 520 and each adhesive roller 506 is configured to rotate about a central axis 502 of the same. In some embodiments, a rod passes through the central axis 502 and is secured at both ends to the object 520.

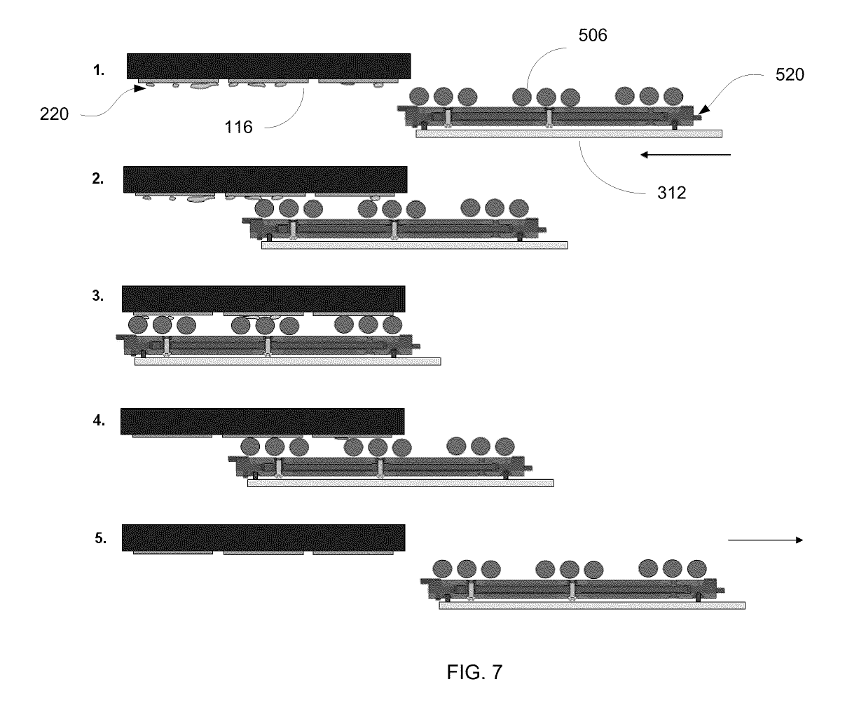

Turning to FIG. 7, a cross sectional view of a plurality of adhesive rollers 506 fixed to an object 520 to clean the clamping surface 116 of the platen 112 is illustrated in different operational positions. To initiate the cleaning operation, the platen 112 would be driven to a similar position 112″ of FIG. 2 with its clamping surface 116 facing downward, or another direction in which gravity aids in the removal of debris, as illustrated in step (1) of FIG. 7. An end effector 312 of a robot may engage the object 520 with the plurality of adhesive rollers 506 fixed thereto. The object 520 may be a mask-like structure so it can be handled by existing handling automation equipment such as robots with associated end effectors. The end effector 312, with the object 520 secured thereto may extend toward the platen 112 as shown in step (2). The end effector 312 with the object 520 may extend so as to contact the entirety of clamping surface 116, as shown in step (3). In step (4), the end effector 312 begins retracting away from the platen 112. In step (5) the end effector 312 retracts away from the platen 112 so as not to be in contact with the platen 112. The end effector 312 may extend to and from the platen 112 in steps (2)-(5) one or more times so that the plurality of adhesive rollers 506 contact the clamping surface 116 to clean the same by removing most, if not all, of the particles 220 stuck to the clamping surface 116. The inverted orientation of the platen 112 ensures that any dislodged particles not adhered to the rollers 506 fall away from the platen 112 due to gravity.

In each of the previously described embodiments, the brush or end effector is described as moving relative to the platen. However, it is understood that in other embodiments, the brush or end effector may be moved to contact the platen, and the platen is then moved, while the brush or end effector remains stationary. In other words, it is the relative movement between the platen and the platen cleaning apparatus that aids in the removal of debris. Relative movement can be accomplished by moving the brush or end effector, the platen, or both components.

The above embodiments disclose the use of gravity to aid in debris removal. However, the disclosure is not limited to these configurations. Certain embodiments may rely only on the action of the platen cleaning apparatus, without the use of gravitational force.

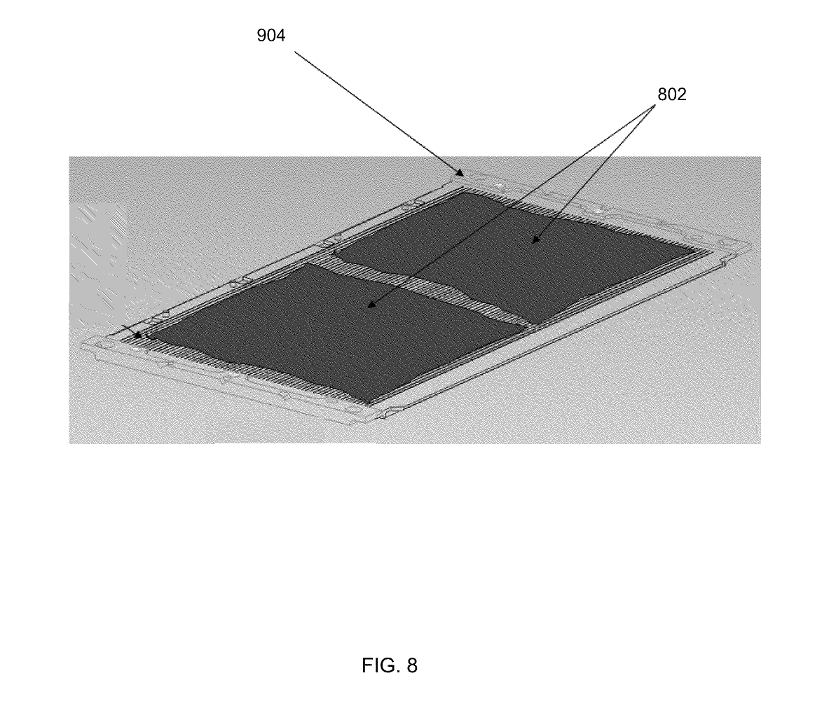

Turning to FIG. 8, yet another embodiment of the present disclosure is illustrated having one or more adhesive sheets 802 affixed to an object 904 that is brought into contact with the clamping surface 116 of the platen 112 to clean the same. The object 904 may be a mask-like structure, where a mask-like structure is a device having a size and shape such that the end effector may engage it as it would a traditional mask. Thus, a mask-like structure includes both masks and similarly shaped carriers or structures. The adhesive sheets 802 include one side to contact the clamping surface 116. This side is fabricated of adhesive material, such as tape, to remove particles from the same while leaving little harmful residue.

In operation, the adhesive sheets 802 have one side that is adhered to an object 904, such as a mask or mask-like structure that can be handled by existing handling automation equipment. The cleaning adhesive side of the adhesive sheet 802 is brought into contact with the clamping surface 116 and particles are removed there from when the adhesive sheet is removed from the clamping surface 116.

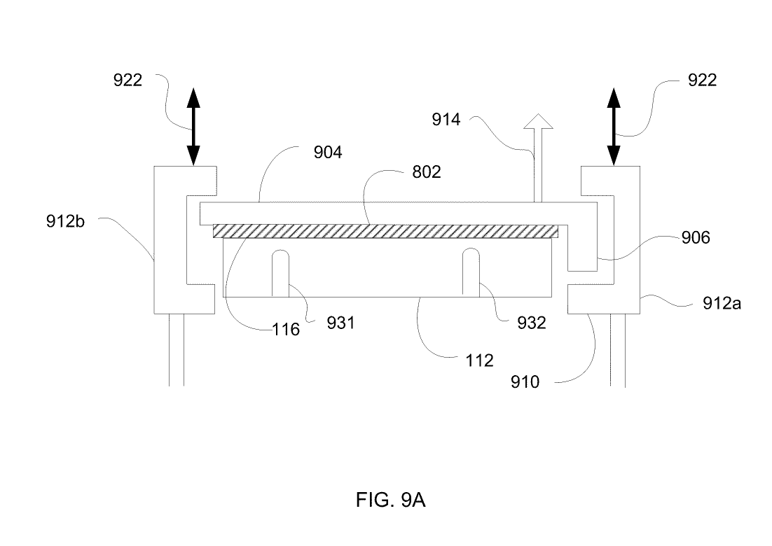

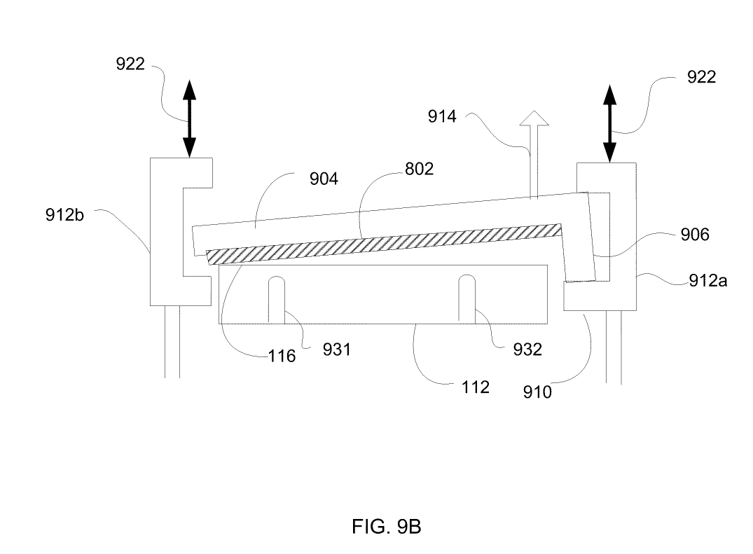

FIGS. 9A-B illustrates one embodiment where an adhesive sheet 802 is affixed to an object 904. The object 904 is driven towards the clamping surface 116 and hence the cleaning side of the adhesive sheet 802 contacts the same. To aid in a controlled removal of the adhesive sheet 802 (by preventing the adhesive sheet 802 from “popping” off), one side of the object 904 may have a downward protrusion 906. When in the cleaning position, the object 904 and adhesive sheet 802 rests flat on the clamping surface 802, as shown in FIG. 9A. Downward protrusion 906 is positioned such that it does not contact the clamping surface 116.

During removal of the adhesive sheet 802, shown in FIG. 9B, a clamping mechanism having brackets 912a, 912b may be driven upward in the direction of arrows 922 so that a shelf 910 of one bracket 912a first contacts the protrusion 906 before any portion of the other bracket 912b contacts the object 904. In this way, one side of the adhesive tape 802 proximate the arrow 914 is first peeled off the clamping surface 116 to promote a peeling effect for disengaging the adhesive sheet 802 and to help prevent a sudden “popping” off of the adhesive sheet 802. FIG. 9B shows the object 904 partially disengaged from the clamping surface 116, as the protrusion 906 is pushed up by bracket 912a.

Alternatively, or in addition to the offset surfaces of FIGS. 9A-B, the lift pins 931, 932 of the platen 112 may also be employed to aid in the peeling or lifting of the adhesive sheet 802 from the clamping surface 116.

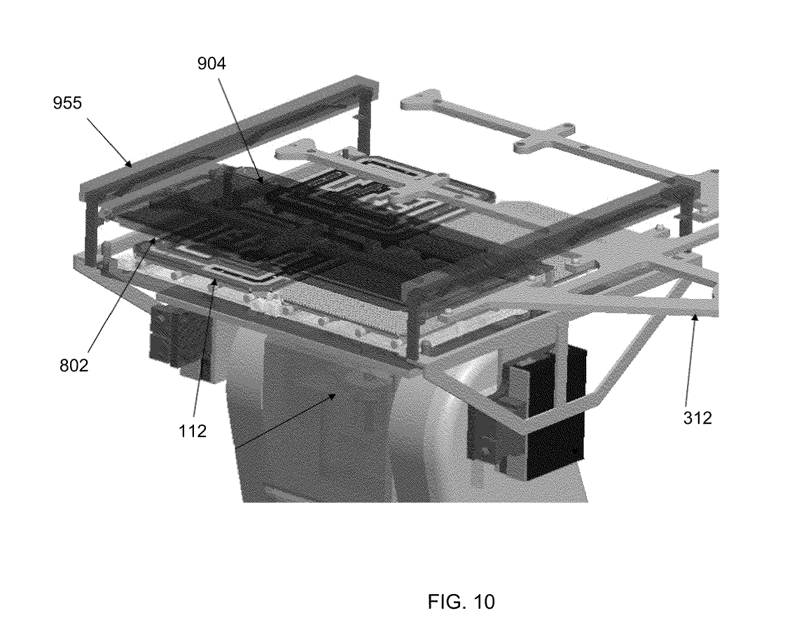

FIG. 10 is a perspective view of one embodiment of the disclosure having an adhesive sheet 802 adhered to a mask-like structure 904 that can be brought into contact with the clamping surface 116 of the platen 112 to clean the same. In this embodiment, the robotic end effector 312 may bring the mask-like structure 904 to the mask clamp/lift 955. The mask clamp/lift 955 lowers the mask-like structure 904 to the platen 112 and clamps it. The adhesive sheet 802 is now in contact with the clamping surface 116 of the platen 112. Subsequently, the mask clamp/lift 955 lifts the mask-like structure 904 off the clamping surface of the platen 112, taking debris with it on the adhesive sheet.

In yet another embodiment consistent with the present disclosure, a cleaning workpiece may be brought into contact with the clamping surface 116. Testing has shown that bringing clean solar cell wafers into contact with the clamping surface 116 of the platen 112 has a cleaning effect by removing some particles adhered thereto. In one method of operation, a solar cell breakage event may leave particles on the clamping surface 116 of the platen 112. One or more clean solar cells may be loaded into and cycled through the ion implanter being clamped and released from the clamping surface until the platen 112 has adequately recovered from the breakage event. Running such test or clean wafers through the implanter can clean the clamping surface 116 without breaking the vacuum condition in the processing station. In this embodiment, the test or clean wafers are clamped and removed from the platen without performing any processing on the wafers. In other words, the wafers are used exclusively for their ability to remove debris from the platen and are not processed.

In yet another embodiment, a single array of jets or a plurality of arrays of jets may direct a cleaning gas towards the clamping surface. The cleaning gas may be nitrogen or other benign process gases to remove particles from the clamping surface 116. The pressure within the processing station may also be varied to maximize particulate removal. In one embodiment, the position of the jets is fixed. In this case, the clamping surface 116 may be scanned across an array of jets. The clamping surface 116 may also be positioned in such a way that gravity does not allow the dislodged particles to redeposit on the clamping surface 116. In another embodiment, the platen may remain stationary, while the gas source is moved. The process of directing a cleaning gas uses a pump and vent cycle. This pump and vent cycle may be repeated several times, as desired.

In yet another embodiment, a low energy ion beam of a particular species may be directed at the clamping surface 116, which is positioned at a high incident angle to effectively have the ion beam provide a glancing blow to the clamping surface. In one embodiment, the species may be argon. The glancing ion beam effectively cleans the clamping surface 116 while enabling the vacuum condition in the processing station to be maintained.

The clamping surface 116 can be exposed to the ion beam in one of more orientations to maximize the cleaning effect, e.g., the platen 112 can rotate about its center four times by 90 degrees each time, thus exposing each quadrant to the high incident angle ion beam.

There has thus been provided platen cleaning apparatuses and methods that enable the ion implanter to maintain high throughput. For workpieces such as solar cells, the throughput of the ion implanter is critical to maintaining a low cost of ownership. The cleaning apparatuses and methods provided herein can be utilized without breaking the vacuum condition in the processing station.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

What is claimed is:

1. A process for removing debris from the surface of a platen located in a processing station used for ion implantation, comprising:
extending a platen cleaning device with bristles disposed on a movable arm such that said bristles contact said surface of said platen; and
creating relative movement between said platen and said bristles, thereby removing said debris from said surface.

2. The process of claim 1, wherein said surface of said platen is rotated so as to face downward prior to said bristles contacting said surface.

3. The process of claim 1, wherein said relative movement is created when said ion implantation is not occurring.

4. The process of claim 1, wherein said movable arm is dedicated to said debris removal operation.

5. The process of claim 1, wherein said movable arm comprises an end effector, wherein said end effector is used to engage and position masks during said ion implantation.

6. The process of claim 5, wherein said movable arm may engage and release said platen cleaning device.

7. The process of claim 5, wherein said platen cleaning device comprises a mask-like structure having bristles affixed to at least a first side.

8. The process of claim 5, wherein said platen cleaning device comprises a mask-like structure having bristles affixed to a first side and a second side opposite said first side.

9. The process of claim 5, wherein said platen cleaning device comprises bristles on a first side and a second side opposite said first side, wherein bristles on said first side are used to clean said surface of said platen, and bristles on said second side are used to clean said end effector.

10. The process of claim 1, wherein said removing is performed without breaking a vacuum condition of said processing station.

11. The process of claim 1, wherein said platen is oriented in a position such that gravity aids in said removing of said debris.

12. The process of claim 1, wherein said bristles are conductive and are electrically grounded.

13. The process of claim 1, wherein said relative movement is created by moving said platen while said bristles remain stationary.

14. The process of claim 1, wherein said relative movement is created by moving said bristles while said platen remains stationary.

15. A process for utilizing and cleaning a platen located in a processing station used for ion implantation, comprising:
positioning said platen in a position suitable for ion implantation;
using a robot end effector to engage a mask, and position said mask in a path of an ion beam;
using said robot end effector to disengage said mask;
using said robot end effector to engage a mask-like structure having a cleaning mechanism on at least one side thereof; and
extending said end effector such that said cleaning mechanism contacts said clamping surface of said platen, thereby removing said debris from said clamping surface.

16. The process of claim 15, further comprising repositioning said platen prior to extending said end effector, such that gravity aids in said removal of said debris.

17. The process of claim 15, wherein said process is performed without breaking a vacuum condition of said processing station.

18. The process of claim 15, wherein said mask-like structure comprises a cleaning mechanism on a first side and a second side opposite said first side, wherein said cleaning mechanism on said first side is used to clean said clamping surface of said platen, and said cleaning mechanism on said second side is used to clean said end effector.

19. The process of claim 15, wherein said cleaning mechanism comprises bristles.

20. The process of claim 15, wherein said cleaning mechanism comprises a plurality of adhesive rollers.

21. The process of claim 15, wherein said end effector extends and retracts one or more times so that said cleaning mechanism moves along said clamping surface.

22. The process of claim 15, wherein said platen moves relative to said cleaning mechanism to remove debris from said platen.

23. A process for utilizing and cleaning a platen located in a processing station used for ion implantation, comprising:
using a robot end effector to engage a mask, and position said mask in a path of an ion beam;
using said robot end effector to disengage said mask;
using said robot end effector to engage a mask-like structure having an adhesive sheet on one side thereof;
positioning said mask-like structure on said clamping surface of said platen;
lifting said mask-like structure from said clamping surface, thereby removing said debris from said clamping surface.

24. The process of claim 23, wherein said mask-like structure comprises a downward protrusion along one edge, such that when a clamping mechanism is driven upward, said one edge lifts off said clamping surface before an opposite edge.
